(19) United States
(12) Patent Application Publication
(10) Pub. No.: US 2002/0121795 A1
(43) Pub. Date: Sep. 5, 2002

(54) Deck lock system

(76) Inventor: Paul Murray, Deer Park, NY (US)

Correspondence Address: Paul Murray, 206 East 4th Street, Deer Park, NY, 11729, US

(21) Appl. No.: 10/054,146

(22) Filed: Jan. 22, 2002

Related U.S. Application Data
(63) Continuation of application No. 09/377,707, filed on Aug. 20, 1999, now abandoned.

(51) Int. Cl. B62D 25/10

(52) U.S. Cl. 296/76

(57) ABSTRACT

A deck lock system for usage in the rear area of a sport utility vehicle and covering the entire rear area of the vehicle, the deck lock system comprising: a deck surface, which comprises a first deck surface panel, a second deck surface panel, and a third deck surface panel. Each panel is substantially horizontal to the floor of the vehicle, each panel attached together along distal edges by a hinge, allowing the first two panels to fold along a vertical axis. A faceplate is securely connected to the deck surface along a front edge, the faceplate extending downwardly from the deck surface in a substantially perpendicular relation, the faceplate extending inwardly from a right side of the vehicle to a left side. The faceplate faces the front of the vehicle; creating a front wall to complete an enclosed storage area. A rear vertical security panel is securely connected to the last rear deck surface panel along a rear inner edge extending downwardly from the deck surface panel in a substantially perpendicular relation. The rear security panel faces the rear of the vehicle, and is connectable to the rear deck surface panel to form a storage area for use when a vehicle seat is utilized. Through usage of the system, a plurality of storage configurations is created above and below the deck surface.

This Application is a continuance of the Application entitled “Deck Lock System” filed by the present Applicant on Aug. 20, 1999, with Ser. No. 09/377,707, in Group Art Unit 3612, before Examiner Joseph D. Pape, with allowable claims noted therein.

### BACKGROUND OF THE INVENTION

1. Field of the Invention

The present invention is a completely securable storage system designed for sport utility vehicles, such as Jeep Wrangler vehicles, with possibilities to work in many other vehicles as well. The present invention, termed the deck lock system, was designed as an improvement over the storage devices of the prior art. The design of the present invention has resolved some long standing issues and shortcomings of the prior art and has maximized the efficiencies and capabilities of such a product of this nature.

2. Description of the Prior Art

Numerous innovations for storage devices have been provided in the prior art that are described as follows. Even though these innovations may be suitable for the specific individual purposes to which they address, they differ from the present invention as hereinafter contrasted. The following is a summary of those prior art patents most relevant to the invention at hand, as well a description outlining the differences between the present invention and the prior art.

1. U.S. Pat. No. 5,324,089, by Schlachter

In the patent to Schlachter, a security enclosure is mounted on the open load deck of a jeep between the rear seat and the tailgate. The load deck, deck sidewalls, and tailgate provide four sidewalls of the security compartment. Top and forward enclosure panels of the security enclosure are movably coupled together for pivotal movement by a hinge. The forward enclosure panel is stabilized by side flanges which are rigidly attached in flush engagement to the load deck side panels. The top enclosure panel is releasably locked to the load deck side panels by spring loaded lock pins which are concealed within the security compartment. According to this arrangement, access to the security compartment and to the lock assembly is controlled by normal operation of the tailgate and its lock. Upon release of the lock pins, the top enclosure panel may be rotated out of the way to provide a top opening access to the load deck for accommodating oversized articles.

2. U.S. Pat. No. 5,669,537, by Saleem

In the patent to Saleem, a storage unit for an automotive vehicle storage area, defined by a floor bounded by generally vertically extending vehicle panels, has a base member, a pair of side supports attached at opposing ends of the base members, a pair of side members hingedly attached to the pair of side supports for pivotable movement between the deployed position and a stored position, a track system on a storage area facing surface of the side members, at least one removable shelf cooperative with the track system for alternatively dividing the storage area into generally vertical or horizontal storage compartments, and manually operable lock members attached to an outboard surface of the side supports and side members for releasable engagement with a lock engagement attached to the vehicle panels. The storage unit has an installed position for dividing the storage area into alternately vertical or horizontal storage compartments, and is collapsible into a transportable position for convenient transit when not installed in the storage area.

3. U.S. Pat. No. 5,615,785, by Kaner

In the patent to Kaner, an in-vehicle device for lifting objects into and out of the storage areas of the vehicle in which it is installed. The device is attached to the inside wall, floor, or ceiling area of the vehicle in which it is installed. It is fixedly attached to the vehicle by a mounting element which is connected to a swivel base element containing, in one embodiment, a winch with a cable running through a telescoping arm protruding from the base. The arm telescopes into and out of the base. The cable has a hook on its end to enable it to hook onto handles or ropes on objects to be stored in the vehicle and removed therefrom to a desired location. The winch is operated manually or by an electric motor or other mechanical means. The mounting element is attached to the vehicle by bolts, rivets, adhesives and the like. The base can be connected to the mounting element by a ball and socket joint to enable it to swivel in all directions, or it can be connected by a joint which enables it to swivel horizontally only. The mounting element can also be fixed to the vehicle by means of brackets. The telescoping arm has a ball and socket wrist joint to enable it to rotate in all directions, enabling it to move the cable with hook to objects not directly below the hook, or to, with the help of the swivel base, unload objects to locations not directly below it.

4. U.S. Pat. No. 5,564,768, by Saffold

In the patent to Saffold, a portable trunk apparatus that creates a large, fully enclosed and secure trunk in the rear bed of trucks and sports utility vehicles. In accordance with the preferred embodiment of the present invention, the portable trunk apparatus is removably manually installable in and removably manually extractable from the truck without using tools. The portable trunk apparatus includes a top wall and a front wall connected together along edges thereof such that a completely enclosed trunk is formed in the rear of the truck when the present invention is properly installed above the floor and in front of the rear wall (and rear gate door) of the truck. Side walls extend along and above and below respective sides of the top wall. The portion of each side wall that extends below their respective side of the top wall functions as a partial side wall of the enclosure. The top wall includes top latches extending from a upper, outer surface of the top wall proximate the rear wall of the truck. The top latches are removably manually inserted under and latch to corresponding rear latches integrally connected to the rear wall of the truck. The front wall includes front latches connected to and extending from a rearward, inner surface thereof. The front latches removably manually latch onto corresponding floor latches mounted to the floor of the truck.

5. U.S. Pat. No. Des254,611, by Linto

In the patent to Linto, an ornamental design for a combined storage compartment, auxiliary rear seat and audio unit for a jeep type vehicle, is shown and described.

6. U.S. Pat. No. Des254,581, by Linto

In the patent to Linto, an ornamental design for a combined storage compartment, auxiliary rear seat and audio unit for a jeep type vehicle, is shown and described.

In summation, there are several prior art patents that each address only one aspect of storage, such as providing a sport utility vehicle with a rear facing trunk-like box, where one was completely absent from the vehicle's original manufacture. Moreover, many prior art inventions create some degree of limitation with their inherent designs, simply due to their size, shape, function, quality, securability, expandability or practicality.

The purpose of the present invention is to eliminate as many of these limitations as possible with one simple modular system. The deck lock system addresses all such aspects of design. The present invention was designed as a complete and universal secured storage system, featuring multiple storage configurations of a modular nature. Thus, as distinguished from those prior patents referenced above, the present invention features a high level of versatility, expandability, and practicality to satisfy many practical storage needs of the sport utility vehicle owner, with particular regards to owners of Jeep Wrangler vehicles.

### SUMMARY OF THE INVENTION

As previously noted, the present invention is designed for sport utility vehicles, such as Jeep Wrangler vehicles, with possibilities to work in many other vehicles as well. The present invention, termed the deck lock system, was designed as an improvement over the storage devices of the prior art. The design of the present invention has resolved some long standing issues and shortcomings of the prior art and has maximized the efficiencies and capabilities of such a product of this nature.

To accomplish the above, the deck lock system of the present invention utilizes all existing features of the sport utility vehicle to secure itself. The invention is modular in that all components rely upon one another to secure the system, using multiple quick and easy attachment points.

The system consists of a deck surface that covers the rear area of the vehicle and is divided into sections. The sections are hinged together at predetermined points to create quick-release connecting points for easy disassembly thereof, and to create a movable hatch or lid for easy access into the storage system.

In the preferred embodiment, the deck is intended to serve three primary purposes. Firstly, the deck creates a large compartment for securing valuables underneath the upper deck surface. Secondly, the top of the deck acts as a payload area for loading and transporting items of various shapes and sizes, which may be lashed down safely and securely with a fastening means unique to the present invention. Finally, the deck may serve as a base unit for attaching add-on storage units of varying sizes and configurations. Such may be accomplished by bolting the add-on items to the deck from underneath the deck, thereby increasing the storage capacity by a significant degree. Thus, the expandability of the present invention can be expected to satisfy the needs of many different users, due to the numerous possible configurations of storage box designs.

The present invention also features a front panel, which completes the enclosed storage area by connecting to the deck surface at an upper edge, and to the floor of the vehicle at a lower edge. This front panel also provides an additional secure surface for the mounting of stereo speakers, which will allow Jeep and other sport utility vehicle owners to upgrade their stereo systems, where such had previously been impractical. Moreover, speakers mounted on the front panel of the deck lock system can be expected to be far more safe from theft and adverse weather conditions than prior mounting methods.

In one embodiment, the present invention allows the user to install the system without the rear seat in place, or with the rear seat in the down position. Such an embodiment allows the user take the entire system, including the rear seat, along on longer road trips. Accordingly, the ability to change the configuration of the system remains with the user at all times, whether it be for transporting persons, cargo, or a combination of both, a new capability not found in prior inventions.

It should be noted that in the present invention not all storage space is lost when utilizing the rear seat for transport. Due to the modular nature of the deck lock system, another configuration option allows a portion of the deck to remain behind the rear seat after all else is removed. In such an instance, there is, with the attachment of an extra panel, a smaller secured storage area created immediately behind the rear seat. Thus, the option provides for a small securable storage area while utilizing the rear seat with passengers. Importantly, such an optional configuration is available to the user upon initial installation of the deck lock system. In any such configuration, access to the storage areas will be allowed from a front top hatch, or by opening the traditional rear tailgate. The aforementioned modular layout of the deck lock system makes the system convenient to install, remove, and store for future use.

The novel features which are considered characteristic for the invention are set forth in the appended claims. The invention itself, however, both as to its construction and its method of operation, together with additional objects and advantages thereof, will be best understood from the following description of the embodiments when read and understood in connection with accompanying drawings.

### BRIEF DESCRIPTION OF THE DRAWINGS

FIG. 1 is a three-quarter perspective view of the rear area of a sport utility vehicle.

FIG. 1A is a three-quarter perspective view of the rear area of a sport utility vehicle with the deck lock system installed therein.

FIG. 2 is a side perspective view of the deck lock system, illustrating the major components therewith.

FIG. 3 is a side perspective view of the deck lock system, illustrating the major components therewith with seat in folded down position.

FIG. 3A is a side perspective view of the deck lock system, illustrating the major components therewith with seat in upright position.

FIG. 4 is a side perspective view of an alternate embodiment of the deck lock system, illustrating the major components therewith.

FIG. 5 is a side perspective view of an alternate embodiment of the deck lock system, illustrating the major components therewith, with optional deckbox.

### DETAILED DESCRIPTION OF THE PREFERRED EMBODIMENT

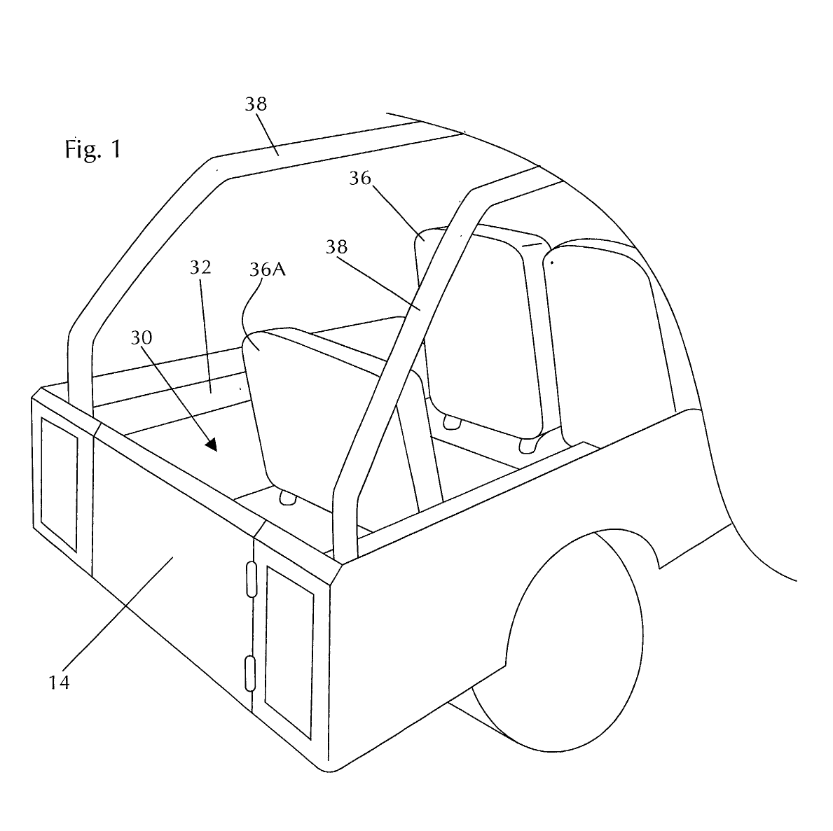

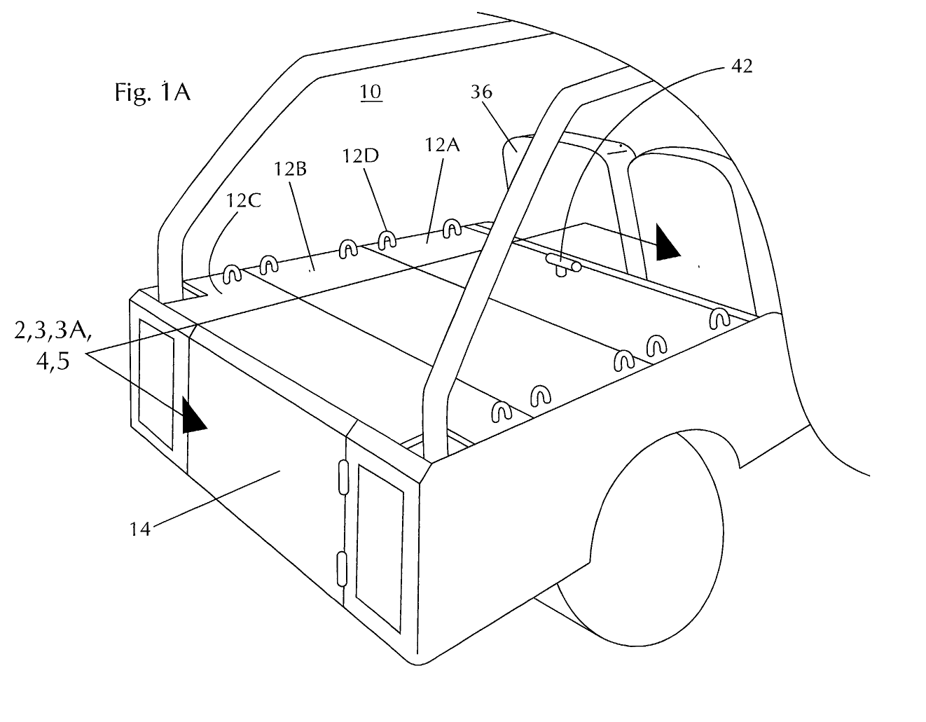

First, referring to FIG. 1, which is a three-quarter perspective view of the rear area of a sport utility vehicle: Illustrated is a traditional open rear cargo area (30) of a sport utility vehicle, and particularly a Jeep-type vehicle. The open compartment is shown for the purposes of comparison to inclusion of the present invention. When using only the traditional embodiment of the rear area of a sport utility vehicle, the user has limited space in which to store or transport items in a safe and secure manner, for instance within wheel well area (32), rear gate (14), seats (36, 36A), and roll bars (38).

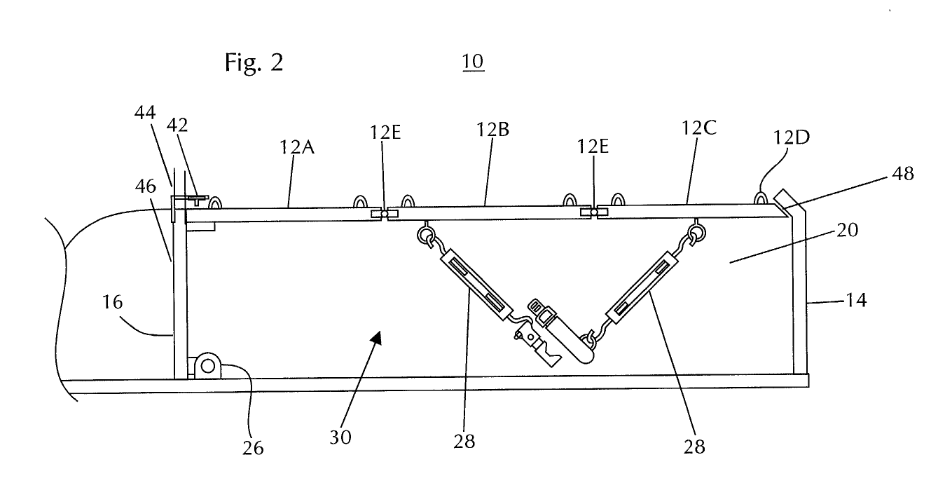

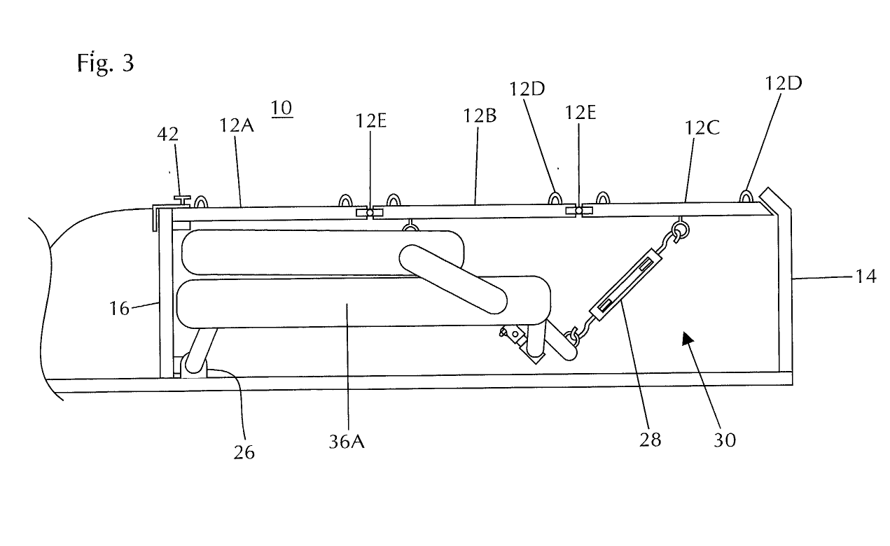

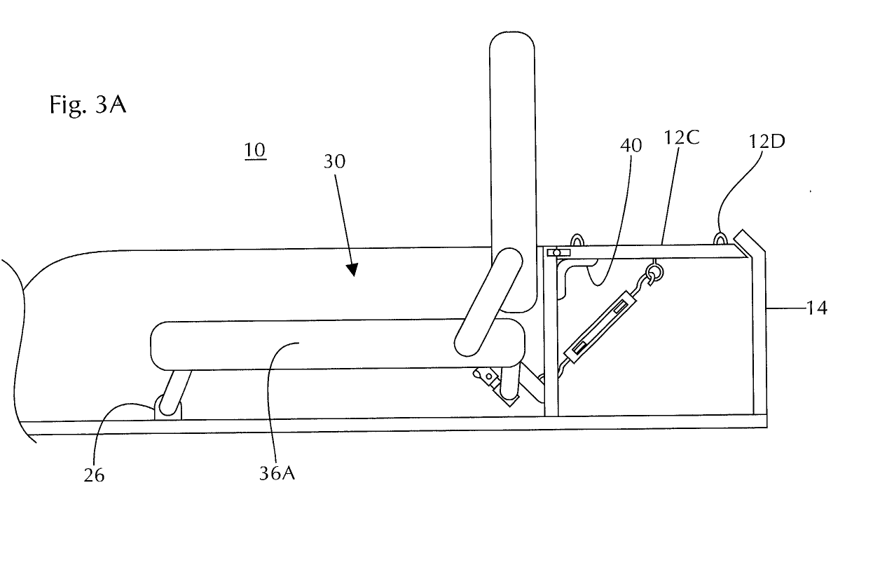

Next, referring to FIG. 1A, FIG. 2, and FIG. 3, the principal component of the present invention, a deck surface, comprises a first deck surface panel (12A), a second deck surface panel (12B), and a third deck surface panel (12C). Each panel is substantially horizontal to the floor of the vehicle, and each panel is attached to the next corresponding panel along distal edges by a hinge means (12E), as shown in FIGS. 2 and 3. This allows each panel to fold along a vertical axis, inwardly or outwardly.

In the deck surface, the three relatively small panels (12A, 12B, and 12C) that are connected together function as one large panel covering the entire rear area of the vehicle. Thus, in the preferred embodiment it extends from the rear tailgate (14) of the vehicle to the front roll bars of the vehicle, which are located behind the front seats (36). The deck surface will also extend from one side wheelwell (32) of the vehicle to the other side wheelwell, conveniently resting upon a top surface of each of them.

Regarding the relationship of the three deck surface panels (12A, 12B, 12C) to one another, this large deck surface panel is formed by connecting the three smaller panels by the means of hinges. The panels are hinged together at their distal edges, substantially width-wise, from one side to the other. This allows the panels to be moved or folded in a front to rear motion when needed.

Further, the two smaller forward panels (12A and 12B) may be hinged together by usage of a stationary hinge (not shown) to create a movable hatch or lid using the very first panel. The panel can be lifted upward or locked in a closed position by means of a paddle or t-handle latch (not shown), as well as by various other mechanisms. Because the first panel (12A) acts as a movable lid, the next small panel connected to it, functions as a stationary roll, acting as an anchor point for the front and rear remaining panels. The last small panel, located at the rear, connects to the second stationary panel at a middle portion thereof by means of removable pin hinges (not shown). In the preferred embodiment, such removable pin hinges (not shown) may only be accessed from the underneath storage area as a form of protection thereof. Such hinges (not shown) may be placed on the bottom side of the deck to prevent tampering with or damage thereto.

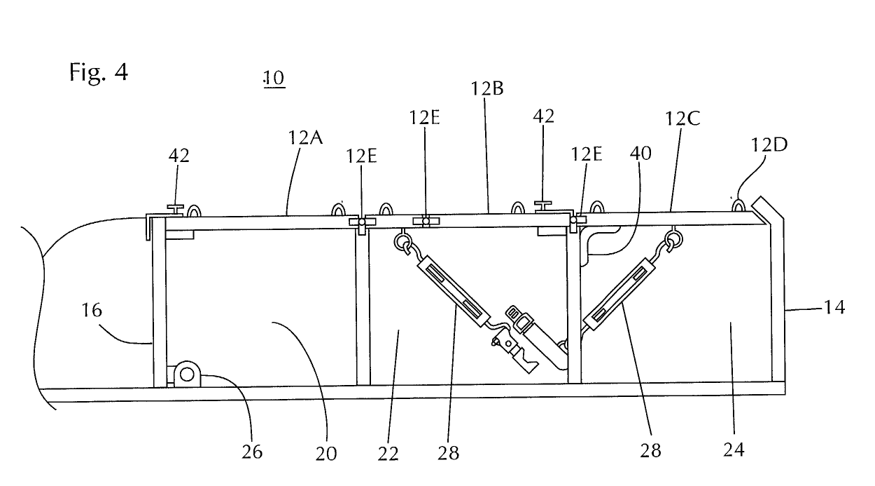

Moreover, the rear panel (12C) rests between two previously existing roll bars of the vehicle and acts as part of a separate storage configuration (24) as depicted in FIG. 4, after the rest of the deck is removed, intended to be used behind the rear seat of the vehicle when the first two panels are removed therefrom. Importantly, all deck surface panels (12A, 12B, 12C) of the present invention may comprise small sidewalls underneath, functioning to elevate the entire deck surface (12) assembly to a position substantially above the previously existing rear seat (36A) with the seat backrest in the down position. The sidewalls of the present invention also assist in maximizing the total storage area without the seat.

The middle and rear smaller panels (12B, 12C) can connect to the vehicle by means of a variety of fasteners, including turnbuckles (28) shown in FIG. 2, from a position underneath the storage area. The underside of the panels may have a connection point, such as an eye bolt or the like (not shown), for one end of the turnbuckle. The other distal end may connect to a previously existing feature of the vehicle. Although such a feature may be contingent upon the exact configuration of the vehicle, as per its particular year, make and model, such is still expected to be effective. Examples of previously existing vehicle features that would be effective for the purposes of the present invention are the seat belt mounts, rear seat sidewall mounts, floor brackets, and roll bars. Additionally, the front panel (12A) may be secured by latching it closed to the faceplate (16) of the present invention.

Mounted on top of the deck surface along the outer edges thereof may be hardware components suitable to allow objects to be tied down thereon, in a stable and secure manner (not shown). In the preferred embodiment, such hardware may be bolted through the deck surface to facilitate safe transport of additional boxes or other cargo items thereon.

The deck lock system also utilizes a faceplate (16) securely connected to the deck surface along a front edge of the deck surface. The faceplate (16) extends downwardly from the deck surface in a substantially perpendicular relation to the deck surface, and also extends inwardly from a right side of the vehicle to a left side of the vehicle. Thus, the faceplate (16) faces the front of the vehicle; creating a front wall to complete an enclosed large storage area under the deck surface.

In the preferred mode, the faceplate (16) is manufactured as one solid piece and rests just behind forward roll bars of the vehicle The faceplate (16) can be notched out on the sides thereof to effectively fit around the vehicle's wheelwells (32).

The present invention may also utilize cutout holes on each the right end and left end of the faceplate (16) for the mounting of stereo speakers thereon. As previously noted, such a feature will allow sport utility vehicle owners to upgrade stereo systems, where such had previously been impractical.

In any such instance, this faceplate (16) may be connected to the vehicle at different points depending on the precise year, make, and model thereof. For example, the faceplate (16) may be attached to the rear seat brackets by the means of additional slip hinges (not shown) mounted both to the back of the faceplate (16) and to the bottom of the seat brackets, thus joined by removable pin connectors (not shown), or for newer Jeep vehicles, such may be connected to the roll bars located on each side. Specifically, the faceplate (16) may be attached to the moveable top hatch cover of the deck surface by means of a lockable paddle or t-handle latch (42) as depicted in FIGS. 2, 3, and 4. The actuating or receiving parts of the latch mechanism may be placed on either the faceplate (16) or the hatch cover. In such an instance, the latch type is the only determining factor in placing the mechanism. In light of the above, the convenient connections of principal components maintain the modular nature of the deck lock system (10).

Furthermore, FIG. 2 illustrates the location of the front roll bars (44) for the purposes of general perspective, as well as the intended location of stereo speakers (46) in the preferred mode, which enhance the utility of the present invention and allow for the most efficient usage of space. Also illustrated is the location of the means to connect the rear security panel to the previously existing vehicle rear panel (48).

Regarding FIG. 3, which again is a side perspective view of the deck lock system, illustrated is an embodiment with rear seat (36A) in the folded down position, with the rear seat (36A) removable held in place by a securement means (26). The functionality of this embodiment is largely the same as that described in connection with FIG. 2 above. With particular regard to the embodiment illustrated in FIG. 3A, a rear security panel is securely connected to a remaining rear deck panel along a rear edge thereof. The rear security panel extends downwardly from the deck surface in a substantially perpendicular relation thereto and faces the rear of the vehicle. Importantly, the rear security panel is connectable to a previously existing vehicle rear panel to form a storage area for use when a vehicle seat is utilized in traditional fashion. This increases the overall versatility and utility of the deck lock system (10).

More specifically, the rear security panel connects to the existing rear deck panel to form a new, smaller storage area that is designed to be utilized when the back seat is being used for its intended purpose. When the two forward panels (12A, 12B) (not shown in FIG. 3A) are removed from the assembly, and the rear panel (12C) remains in place, the rear security panel connects by similar means to that outlined above, wherein such may be by the usage of removable pin hinges and “L” brackets (not shown). The panel in question will rest vertically from the top edge of the rear deck panel (12C) nearest the front to the bottom of the floorboard of the vehicle. Thus, it will conveniently extend between the two previously existing rear wheelwells, acting as a wall to create a small enclosed storage area once the rear door is closed. One method of further securing this panel may be to utilize angle brackets (not shown) to prevent the panel from being pulled outwardly. In such a case, the angle brackets may remain on the rear security panel and may be connected to the rear deck panel (12C) by means such as a small bolt on each side (not shown). This newly created storage area will thus rest immediately behind the previously existing rear seat, again retaining the modular characteristics of the present invention.

Referring specifically to FIG. 4, which is a side perspective view of an alternate embodiment of the present invention, illustrated is an assembly of modular components forming a total of three separate storage compartments, each below the primary deck surface. The embodiment depicted in FIG. 4 provides an additional option to the user of the system for the purposes of versatility, as it includes the usage of a front compartment (20), middle compartment (22), and rear compartment (24), below previously mentioned two forward panels (12A, 12B) and rear deck panel (12C).

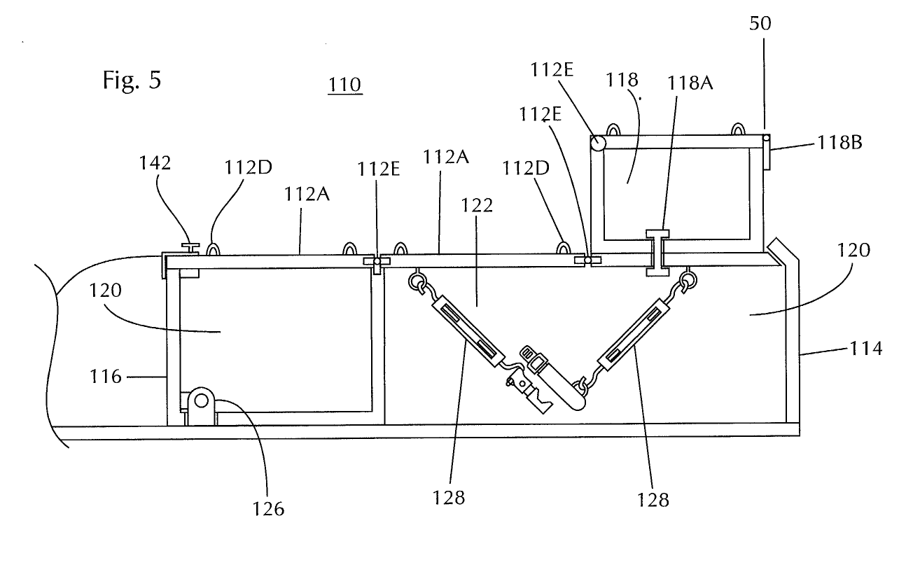

Referring specifically to FIG. 5, which is a side perspective view of the deck lock system, illustrated are the major components with an optional deckbox (118). In this third embodiment, a deckbox (118), or boxes are simply additional storage containers to the system and may connect to the top of the deck surface, in various locations and positions. Such may be accomplished by means of bolting down the container from underneath the deck surface (118A) through pre-drilled holes in both the container and deck surface. When the deckbox lids and rear doors of the system are in the closed position, the boxes will be totally secured. This style of connection and securement means collectively function to maintain the modular nature of the system to the ultimate benfit of the user.

In addition, FIG. 5 illustrates the intended location of the deckbox clamp (50), at the top right portion of the FIGURE, specifically at the upper front-facing corner of the deck box. This functions to allow the deckbox to conveniently close and lock, to protect any of a variety of items placed therein by the user.

It will be understood that each of the elements described above, or two or more together, may also find a useful application in other types of constructions differing from the type described above.

While the invention has been illustrated and described as embodied, it is not intended to be limited to the details shown, since it will be understood that various omissions, modifications, substitutions and changes in the forms and details of the device illustrated and in its operation can be made by those skilled in the art without departing in any way from the spirit of the invention.

The foregoing will reveal the gist of the present invention that others can readily adapt it for various applications without omitting features that, from the standpoint of prior art, constitute essential characteristics of the generic or specific aspects of this invention.

What is claimed as new and desired to be protected by Letters Patent is set forth in the appended claims.

1. A deck lock system (10) for usage in the rear area of a sport utility vehicle, the deck lock system (10) comprising:
A. a deck surface which includes a first deck surface panel (12A), a second deck surface panel (12B), and a third deck surface panel (12C), each substantially horizontal to the floor of the vehicle, each panel attached together along distal edges by a hinge means (12E) allowing each panel to fold along a vertical axis, an underside of each panel comprising a connection point for a turnbuckle (28), a distal end of the turnbuckle (28) connecting to previously existing seat belt mounts (26) and previously existing rear seat (36A) sidewall mounts, second and third panels (12B, 12C) connect to the vehicle by means of turnbuckles (28), the deck surface covering the entire rear area of the vehicle, and extending from a first side wheelwell to a second side wheelwell, the deck surface resting on a top surface of each wheelwell, the deck surface also comprising a securable latching attachment means;
B. a faceplate (16) securely connected to the deck surface along a front edge of the deck surface, the faceplate (16) extending downwardly from the deck surface in a substantially perpendicular relation thereto, the faceplate (16) extending from a right side of the vehicle to a left side of the vehicle the faceplate (16) facing the front of the vehicle, faceplate (16) attached to previously existing rear seat brackets by slip hinges mounted to a back surface of the faceplate (16), and joined by removable pin connectors, creating a front wall to complete an enclosed storage area;
C. a rear security panel securely connected to the deck surface along a rear edge of the deck surface, the rear security panel extending downwardly from the deck surface in a substantially perpendicular relation thereto, the rear security panel facing the rear of the vehicle, the rear security panel connectable to a previously existing vehicle rear panel to form the storage area for use when a vehicle seat is utilized, the storage compartment created vertically between the deck surface (12) and the floor of the vehicle, and created horizontally between the faceplate (16) and the rear security panel (14); and
D. a plurality of deckboxes (118) are removably attached to a top surface of the deck surface by an attachment means, the deckboxes (118) functioning as an additional storage containers thereon, the deckboxes (118) comprising deckbox clasps which function to allow for locking and unlocking thereof.

2. The deck lock system (10) as described in claim 1, wherein the system allows for a previously existing seat (36A) of the vehicle to be folded downwardly and stored within the storage area.

3. The deck lock system (10) as described in claim 1, wherein the faceplate (16) comprises stereo speakers mounted thereon.

4. The deck lock system (10) as described in claim 1, wherein the first deck surface panel (12A) and the second deck surface panel (12B) are hinged together by a stationary hinge (12E), creating a movable hatch.

5. The deck lock system (10) as described in claim 1, wherein the first deck surface panel (12A) acts as a movable lid, the second deck surface panel (12B) connected thereto is stationary, functioning to create an anchor point for the third deck surface panel (12C).

6. The deck lock system (10) as described in claim 1, wherein the third deck surface panel (12C) connects to the second deck surface panel (12B) by means of removable pin hinges, accessible from the underneath storage area.

7. The deck lock system (10) as described in claim 1, wherein the rear deck surface panel (12C) rests between previously existing roll bars (38).

8. The deck lock system (10) as described in claim 1, wherein the faceplate (16) rests at a position behind previously existing forward roll bars (38), the faceplate (16) comprising notches to fit around wheelwells (32) of the vehicle.

9. The deck lock system (10) as described in claim 1, wherein the rear security panel (12C) extends between two rear wheelwells (32) acting as a wall, creating the enclosed storage area behind a rear seat (36A), utilized when the forward panels (12A, 12B) are removed and a rear door is in the closed position.
